(19) United States
(12) Patent Application Publication
(10) Pub. No.: US 2022/0075844 A1
(43) Pub. Date: Mar. 10, 2022

(54) FAST SPARSE OPTIMIZATION DEVICE, FAST SPARSE OPTIMIZATION METHOD, AND PROGRAM

(71) Applicant: NIPPON TELEGRAPH AND TELEPHONE CORPORATION, Tokyo (JP)

(72) Inventors: Shinsaku SAKAUE, Tokyo (JP); Masaaki NAGATA, Tokyo (JP)

(73) Assignee: NIPPON TELEGRAPH AND TELEPHONE CORPORATION, Tokyo (JP)

(21) Appl. No.: 17/417,352

(22) PCT Filed: Dec. 17, 2019
(86) PCT No.: PCT/JP2019/049396

§ 371 Date: Jun. 22, 2021

(30) Foreign Application Priority Data
Dec. 25, 2018 (JP) 2018-240666

(51) Int. Cl. G06F 17/16

(52) U.S. Cl. CPC G06F 17/16

(57) ABSTRACT

An object is to make it possible to find a high-quality solution at a high speed even for a nonconvex sparse optimization problem of bad conditions. A computation unit 130 computes, with respect to each element that is not included in a set of nonzero elements that is previously obtained or an initial value of the set of nonzero elements, an optimum value of an objective function in a case in which elements that are allowed to be nonzero elements are only elements included in a set that is obtained by adding the element not included in the set of nonzero elements to the set of nonzero elements. A main processing unit 120 selects added elements in the order of optimum values of the objective function and adds the selected elements to the set of nonzero elements, the number of selected elements being an addition upper limit number determined in advance for each number of times of repetition such that a sum total of addition upper limit numbers is a predetermined number, the elements being selected such that an element with which a preferable optimum value can be obtained is preferentially selected. A determination unit 140 causes the computation unit 130 to repeatedly perform computation and causes the main processing unit 120 to repeatedly perform selection and addition. An output unit 150 outputs a value of the variable vector that optimizes the value of the objective function when only the set of nonzero elements is allowed to be nonzero elements.

### TECHNICAL FIELD

The present invention relates to a high-speed sparse optimization device, a high-speed sparse optimization method, and a program, and particularly to a high-speed sparse optimization device, a high-speed sparse optimization method, and a program for finding a solution to a nonconvex sparse optimization problem at a high speed.

### BACKGROUND ART

A nonconvex sparse optimization problem that appears in the field of sparse estimation or the like is a problem of optimizing the value of an objective function

l(x)
regarding a variable vector

### X

that includes d elements, under the constraint that the variable vector

### X

only includes k nonzero (i.e., not equal to zero) elements.

The nonconvex sparse optimization problem appears, for example, in a situation in which noise is to be removed from a signal that includes d values on which noise is superimposed and the value of a true signal that is constituted by k nonzero elements is to be restored.

Studies have been carried out to find a solution to a nonconvex sparse optimization problem using high-speed methods as described in NPL 1 to NPL 3 and a method that is based on a greedy algorithm as described in NPL 4.

### CITATION LIST

### Non Patent Literature

[NPL 1] Jain, P., Tewari, A., and Kar, P. On iterative hard thresholding methods for high-dimensional M-estimation. In Advances in Neural Information Processing Systems 27. Curran Associates, Inc., 2014, pp. 685-693.
[NPL 2] Yuan, X., Li, P., and Zhang, T. Exact recovery of hard thresholding pursuit. In Advances in Neural Information Processing Systems 29. Curran Associates, Inc., 2016, pp. 3558-3566.
[NPL 3] Marsousi, M., Abhari, K., Babyn, P., and Alirezaie, J. MULTI-STAGE OMP sparsecoding using local matching pursuit atoms selection. In 2013 IEEE International Conference on Acoustics, Speech and Signal Processing, 2013, pp. 1783-1787.
[NPL 4] Elenberg, E. R., Khanna, R., Dimakis, A. G., and Negahban, S. Restricted strongconvexity implies weak submodularity. Ann. Statist., 46(6B), 2018, pp. 3539-3568.

### SUMMARY OF THE INVENTION

### Technical Problem

However, with the methods described in NPL 1 to NPL 3, it is possible to output a solution at a high speed, but depending on the problem, a poor-quality solution may be output with the value of the objective function

l(x)
being not the optimum.

More specifically, with these existing methods, it is possible to output a high-quality solution to a nonconvex sparse optimization problem of good conditions in which data constituting the problem is not biased, but in the case of a solution that is output with respect to a problem of bad conditions in which data is biased, the quality of the solution is likely to be low.

On the other hand, with the method based on the greedy algorithm (NPL 4), it is possible to output a relatively good solution even for a problem of bad conditions, when compared to the above-described high-speed methods. However, this method is difficult to apply to a large-scale problem because running time is likely to be long.

The present invention was made in view of the foregoing, and an object of the present invention is to provide a high-speed sparse optimization device, a high-speed sparse optimization method, and a program with which it is possible to find a high-quality solution at a high speed even for a nonconvex sparse optimization problem of bad conditions.

### Means for Solving the Problem

A high-speed sparse optimization device according to the present invention is a high-speed sparse optimization device configured to find a value of a variable vector that optimizes the value of an objective function under the constraint that the variable vector includes at most a predetermined number of nonzero elements, the high-speed sparse optimization device including: a computation unit configured to compute, with respect to each element that is not included in a set of nonzero elements that is previously obtained or an initial value of the set of nonzero elements, an optimum value of the objective function in a case in which elements that are allowed to be nonzero elements are only elements included in a set that is obtained by adding the element that is not included in the set of nonzero elements to the set of nonzero elements; a main processing unit configured to select the added elements in the order of optimum values of the objective function and add the selected elements to the set of nonzero elements, the number of selected elements being an addition upper limit number determined in advance for each number of times of repetition such that a sum total of addition upper limit numbers is the predetermined number, the elements being selected such that an element with which a preferable optimum value of the objective function can be obtained is preferentially selected; a determination unit configured to cause the computation unit to repeatedly perform computation and cause the main processing unit to repeatedly perform selection and addition a predetermined number of times of repetition; and an output unit configured to output a value of the variable vector that optimizes the value of the objective function when only the set of nonzero elements is allowed to be nonzero elements.

A high-speed sparse optimization method according to the present invention is a high-speed sparse optimization method for finding a value of a variable vector that optimizes the value of an objective function under the constraint that the variable vector includes at most a predetermined number of nonzero elements, the high-speed sparse optimization method including: computing, by a computation unit, with respect to each element that is not included in a set of nonzero elements that is previously obtained or an initial value of the set of nonzero elements, an optimum value of the objective function in a case in which elements that are allowed to be nonzero elements are only elements included in a set that is obtained by adding the element that is not included in the set of nonzero elements to the set of nonzero elements; selecting, by a main processing unit, the added elements in the order of optimum values of the objective function and adding the selected elements to the set of nonzero elements, the number of selected elements being an addition upper limit number determined in advance for each number of times of repetition such that a sum total of addition upper limit numbers is the predetermined number, the elements being selected such that an element with which a preferable optimum value of the objective function can be obtained is preferentially selected; causing, by a determination unit, the computation unit to repeatedly perform computation and causing the main processing unit to repeatedly perform selection and addition a predetermined number of times of repetition; and outputting, by an output unit, a value of the variable vector that optimizes the value of the objective function when only the set of nonzero elements is allowed to be nonzero elements.

In the high-speed sparse optimization device and the high-speed sparse optimization method according to the present invention, the computation unit computes, with respect to each element that is not included in a set of nonzero elements that is previously obtained or an initial value of the set of nonzero elements, an optimum value of an objective function in a case in which elements that are allowed to be nonzero elements are only elements included in a set that is obtained by adding the element that is not included in the set of nonzero elements to the set of nonzero elements, and the main processing unit selects the added elements in the order of optimum values of the objective function and add the selected elements to the set of nonzero elements, the number of selected elements being an addition upper limit number determined in advance for each number of times of repetition such that a sum total of addition upper limit numbers is the predetermined number, the elements being selected such that an element with which a preferable optimum value of the objective function can be obtained is preferentially selected.

The determination unit causes the computation unit to repeatedly perform computation and causes the main processing unit to repeatedly perform selection and addition a predetermined number of times of repetition, and the output unit outputs a value of the variable vector that optimizes the value of the objective function when only the set of nonzero elements is allowed to be nonzero elements.

It is possible to find a high-quality solution at a high speed even for a nonconvex sparse optimization problem of bad conditions by computing, with respect to each element that is not included in a set of nonzero elements that is previously obtained or an initial value of the set of nonzero elements, an optimum value of an objective function in a case in which elements that are allowed to be nonzero elements are only elements included in a set obtained by adding the element not included in the set of nonzero elements to the set of nonzero elements, selecting the added elements in the order of optimum values of the objective function and adding the selected elements to the set of nonzero elements, the number of selected elements being an addition upper limit number determined in advance for each number of times of repetition such that a sum total of addition upper limit numbers is a predetermined number, the elements being selected such that an element with which a preferable optimum value can be obtained is preferentially selected, repeatedly performing computation, selection, and addition, and outputting a value of the variable vector that optimizes the value of the objective function when only the set of nonzero elements is allowed to be nonzero elements, as described above.

The high-speed sparse optimization device according to the present invention can also be configured such that the addition upper limit number determined in advance for each number of times of repetition is greater than or equal to 1, and at least one of the addition upper limit numbers is greater than or equal to 2.

A program according to the present invention is a program for causing a computer to function as each unit of the above-described high-speed sparse optimization device.

### Effects of the Invention

With the high-speed sparse optimization device, the high-speed sparse optimization method, and the program according to the present invention, it is possible to find a high-quality solution at a high speed even for a nonconvex sparse optimization problem of bad conditions.

### BRIEF DESCRIPTION OF DRAWINGS

FIG. 1 is a schematic diagram showing a configuration of a high-speed sparse optimization device according to an embodiment of the present invention.

FIG. 2 is a diagram showing one example of an algorithm of high-speed sparse optimization processing according to the embodiment of the present invention.

FIG. 3 is a graph showing running time of the high-speed sparse optimization device according to the embodiment of the present invention.

FIG. 4 is a graph showing training errors of the high-speed sparse optimization device according to the embodiment of the present invention.

FIG. 5 is a flowchart showing a high-speed sparse optimization processing routine of the high-speed sparse optimization device according to the embodiment of the present invention.

### DESCRIPTION OF EMBODIMENTS

The following describes an embodiment of the present invention using the drawings.

### Principle of High-Speed Sparse Optimization Device According to Embodiment of the Invention

First, principles of the embodiment of the present invention will be described.

In the present embodiment, a method that is based on a greedy algorithm is speeded up to make it possible to output a high-quality solution at a high speed even for a problem of bad conditions.

As specific means for speeding up, a multistage greedy algorithm (Reference Document 1) that is devised for a problem other than the nonconvex sparse optimization problem is used.
[Reference Document 1] Wei, K., Iyer, R., and Bilmes, J. Fast multi-stage submodular maximization. In Proceedings of the 31st International Conference on Machine Learning, volume 32 of Proceedings of Machine Learning Research. PMLR, 22-24 Jun. 2014, pp. 1494-1502.

First, assume that [d]={1, 2, . . . , d} is a set of suffixes of a variable vector

### X.

Also, assume that
∥x∥₀
is the number of nonzero elements of the variable vector

### X, and

supp(x)⊆[d]

is a set of suffixes of the nonzero elements of the variable vector

### X.

Also, assume that

l: [symbol] ^{[d]}→

[symbol]

is an objective function that has the variable vector

### X

as an argument.

The objective function

l(x)
is a function for evaluating the likelihood of being a true signal in a situation in which noise is to be removed from a signal that includes d values on which noise is superimposed and the value of the true signal that is constituted by a predetermined number k of nonzero elements is to be restored, for example, and the smaller the value of the objective function is, the higher the likelihood of being the true signal is, i.e., the minimum value is the optimum, for example.

In the present embodiment, a nonconvex sparse optimization problem of finding a solution according to which the number of nonzero elements of the variable vector

### X

is not larger than the predetermined number k (upper limit number) and that optimizes the value of the objective function
l(x)
as far as possible will be considered. In the following description of the present embodiment, a case will be described as an example in which the minimum value of the objective function
l(x)
is the optimum and a nonconvex sparse optimization problem of finding a solution that makes the value of the objective function as small as possible is considered.

This problem can be formulated as the following expression (1).

$$[ Math . 1 ]$$

$${minimize}_{x ∈ {ℝ}^{[ d ]}} l ( x ) subject to {‖ x ‖}_{0} \leq k \qquad ( 1 )$$

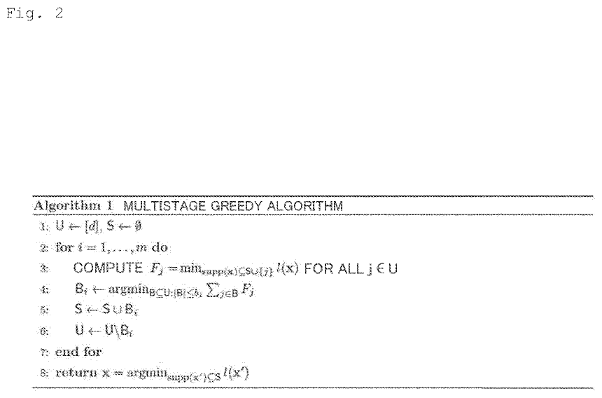

Details of a multistage greedy algorithm for this problem are shown in FIG. 2. FIG. 2 is a diagram showing one example of an algorithm of high-speed sparse optimization processing according to the embodiment of the present invention.

The predetermined number k, which is an allowable number of nonzero elements, the objective function l(⋅), and addition upper limit numbers b₁, . . . , and bₙ, which are m positive integers determined in advance and satisfy

Σᵢ₌₁^{m}bᵢ=k

are input to the algorithm shown in FIG. 2, and the algorithm outputs the vector
x
as a solution.

In a usual greedy algorithm, suffixes that make the value of the objective function

l(x)
smallest if the suffixes are allowed to be nonzero are repeatedly added. That is,

j∈U⊆[d]

that minimizes a suffix Fⱼ shown by the following expression (2) is selected in each repetition and added to a current solution S.

$$[ Math . 2 ]$$

$${F}_{j} = {min}_{supp ( x ) ⊆ S ⋃ \{ j \}} l ( x ) \qquad ( 2 )$$

On the other hand, in the multistage greedy algorithm, bᵢ suffixes are selected in i-th repetition from a set U in the ascending order of values of the suffix Fⱼ, and a set of the suffixes

Bᵢ⊆U

is added to S. Here, an addition upper limit number bᵢ that is determined in advance for each number of times of repetition is greater than or equal to 1, and at least one addition upper limit number bᵢ among addition upper limit numbers b₁, . . . , and bₘ is greater than or equal to 2.

Thus, suffixes of nonzero elements are collectively added in each repetition to reduce the labor of computing the value of Fⱼ and realize an operation faster than that of the usual greedy algorithm.

### Configuration of High-Speed Sparse Optimization Device According to Embodiment of the Invention

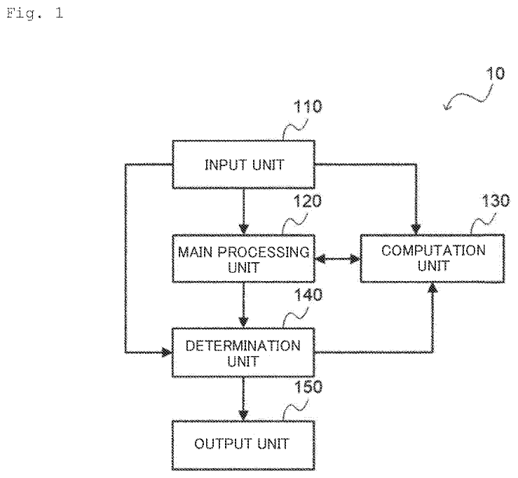

A configuration of a high-speed sparse optimization device 10 according to the embodiment of the present invention will be described with reference to FIG. 1. FIG. 1 is a block diagram showing the configuration of the high-speed sparse optimization device 10 according to the embodiment of the present invention.

The high-speed sparse optimization device 10 is constituted by a computer that includes a CPU, a RAM, and a ROM in which a program for executing a high-speed sparse optimization processing routine, which will be described later, is stored, and is functionally configured as described below.

As shown in FIG. 1, the high-speed sparse optimization device 10 according to the present embodiment includes an input unit 110, a main processing unit 120, a computation unit 130, a determination unit 140, and an output unit 150.

The input unit 110 accepts input of the objective function

l(x).
the predetermined number k of nonzero elements, the addition upper limit numbers b₁ to bₘ for respective numbers of times of repetition, and the set [d] of suffixes of the variable vector

### X.

Here, the addition upper limit number bᵢ determined in advance for each number of times of repetition is greater than or equal to 1, at least one addition upper limit number bᵢ among the addition upper limit numbers b₁, . . . , and bₘ is greater than or equal to 2, and

Σᵢ₌₁^{m}bᵢ=k

is satisfied.

Then, the input unit 110 gives the accepted objective function

l(x),
the predetermined number k of nonzero elements, the addition upper limit numbers b₁ to bₘ for respective numbers of times of repetition, and the set [d] of suffixes to the main processing unit 120. Also, the input unit 110 gives the objective function
l(x)
to the computation unit 130, and gives the number m of addition upper limit numbers b₁ to bₘ for respective numbers of times of repetition to the determination unit 140.

The main processing unit 120 selects elements j in the order of optimum values of the objective function

l(x)
that are obtained when the elements j are respectively added to a set S of nonzero elements, and adds the selected elements j to the set S of nonzero elements, the number of selected elements being the addition upper limit number bᵢ determined in advance for each number i of times of repetition such that a total sum of addition upper limit numbers bᵢ is the predetermined number k, the elements j being selected such that an element with which a preferable optimum value of the objective function can be obtained is preferentially selected.

Specifically, the main processing unit 120 first initializes the set S of nonzero elements to

∅,
and initializes a suffix set U that is constituted by suffixes of elements that are not included in the set S to the set [d] of suffixes.

Next, the main processing unit 120 gives the initialized set S of nonzero elements and the initialized suffix set U to the computation unit 130.

Upon accepting optimum values Fⱼ that are computed by the computation unit 130 regarding respective elements j that are not included in the set S of nonzero elements, the main processing unit 120 selects added elements j in the ascending order of the optimum values FI and adds a set Bᵢ of the selected elements j to the previously obtained set S of nonzero elements, the number of selected elements j being the addition upper limit number bᵢ. Also, the main processing unit 120 deletes the elements j included in the set Bᵢ added to the set S of nonzero elements from the suffix set U.

Then, the main processing unit 120 gives the objective function

l(x),
the addition upper limit numbers b₁ to bₘ for respective numbers of times of repetition, the set S of nonzero elements, and the suffix set U to the determination unit 140.

The computation unit 130 computes, with respect to each element j that is not included in a set S of nonzero elements that is previously obtained or an initial value of the set S of nonzero elements, an optimum value of the objective function

l(x)
in a case in which elements that are allowed to be nonzero elements are only elements included in a set that is obtained by adding the element j that is not included in the set S of nonzero elements to the set S of nonzero elements.

Specifically, based on the objective function

l(x)
acquired from the input unit 110, and a set S of nonzero elements and the suffix set U that are acquired from the main processing unit 120 or the determination unit 140, the computation unit 130 performs computation of the above expression (2) with respect to each element j included in the suffix set U to find an optimum value Fⱼ of the objective function
l(x).

Then, the computation unit 130 gives the optimum value Fⱼ of the objective function

l(x)
with respect to each element j included in the suffix set U to the main processing unit 120.

The determination unit 140 causes the computation unit 130 to repeatedly perform computation and causes the main processing unit 120 to repeatedly perform selection and addition a predetermined number m of times of repetition.

Specifically, the determination unit 140 determines whether or not the number of times of repetition is at least m.

If the number of times of repetition is smaller than m, the determination unit 140 gives the set S of nonzero elements and the suffix set U to the computation unit 130, and causes the computation unit 130 to repeatedly perform computation and causes the main processing unit 120 to repeatedly perform selection and addition.

On the other hand, if the number of times of repetition is at least m, the determination unit 140 gives the objective function

l(x),
the addition upper limit numbers b₁ to bₘ for respective numbers of times of repetition, the set S of nonzero elements, and the suffix set U to the output unit 150.

The output unit 150 outputs a value of the variable vector

### X

that optimizes the value of the objective function
l(x)
when only the set S of nonzero elements is allowed to be nonzero elements.

Specifically, based on the objective function

l(x)
and the set S of nonzero elements, the output unit 150 first computes a value of the variable vector

### X

that minimizes the value of the objective function l(x)
when only the set S of nonzero elements is allowed to be nonzero elements, by using the following expression (3).

[Math. 3]

x=argmin_{supp(x′)⊆S}l(x′) (3)

Then, the output unit 150 outputs the computed value of the variable vector

### X

that minimizes the value of the objective function
l(x).

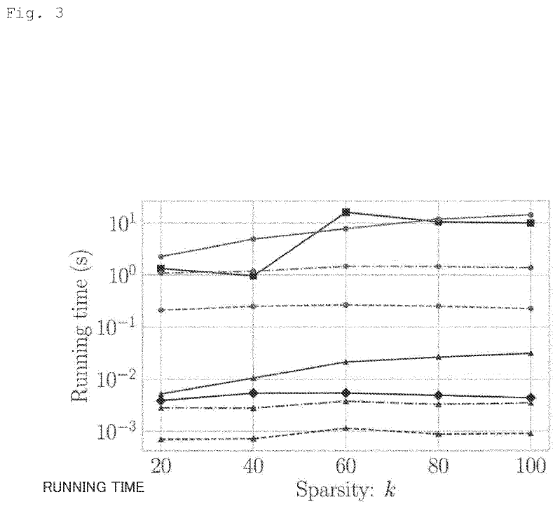

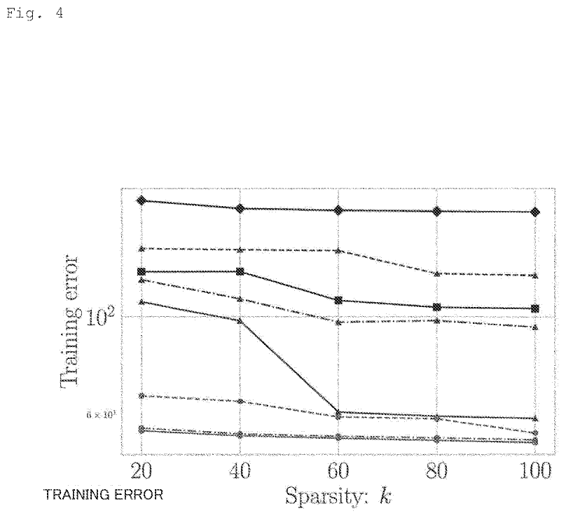

FIGS. 3 and 4 show execution results obtained using the high-speed sparse optimization device 10 (multistage greedy algorithm) according to the present embodiment and execution results obtained by applying the methods described in NPL 1 to NPL 4 to a problem of bad conditions. FIG. 3 shows a relationship between the predetermined number k and running time in a case in which the predetermined number k, which is the upper limit number of allowed nonzero elements, is changed, and FIG. 4 shows a relationship between the predetermined number k and training errors in a case in which the predetermined number k is changed. In FIG. 4, a smaller training error indicates a higher quality of a solution.

In FIGS. 3 and 4, lines that include squares, rhombuses, and triangles show experiment results obtained using high-speed methods (NPL 1 to NPL 3) and solid lines that include circles show experiment results obtained using a usual greedy algorithm (NPL 4).

In FIGS. 3 and 4, two types of dotted lines including circles show experiment results obtained using the multistage greedy algorithm, and two results were obtained according to the method for determining the number m of times of repetition.

FIG. 3 shows that the multistage greedy algorithm of the method according to the present embodiment operates faster than the greedy algorithm and operates at a speed equivalent to or faster than the speed of one of the high-speed methods (NPL 1).

On the other hand, FIG. 4 shows that the quality of solutions obtained using the method according to the present embodiment is slightly inferior to the quality of solutions obtained using the greedy algorithm shown by the solid line including circles, but is superior to the quality of solutions obtained using the other high-speed methods.

As described above, it was confirmed that the high-speed sparse optimization device 10 according to the present embodiment could efficiently compute high-quality solutions to a problem of bad conditions.

### Functions of High-Speed Sparse Optimization Device According to Embodiment of the Invention

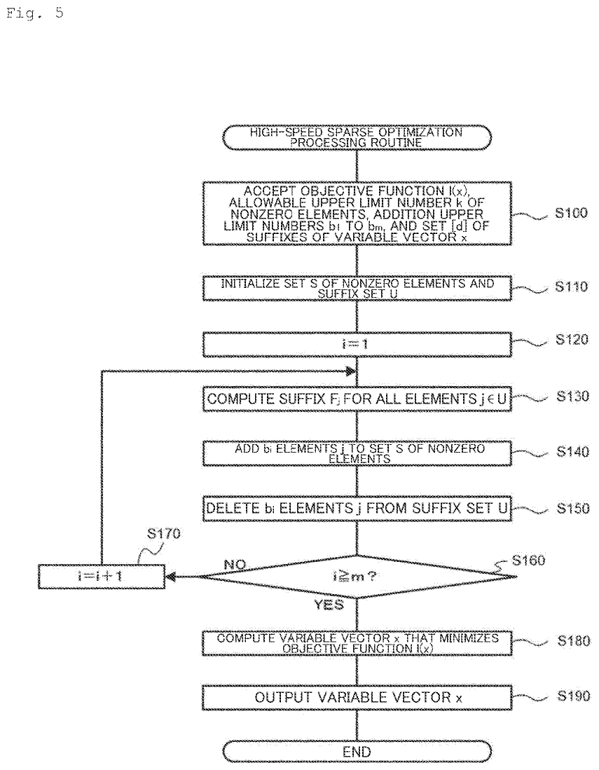

FIG. 5 is a flowchart showing a high-speed sparse optimization processing routine according to the embodiment of the present invention.

The high-speed sparse optimization processing routine shown in FIG. 5 is executed in the high-speed sparse optimization device 10 when the objective function

l(x),
the predetermined number k of nonzero elements, the addition upper limit numbers b₁ to bₘ, for respective numbers of times of repetition, and the set [d] of suffixes of the variable vector

### X

are input to the input unit 110.

First, in step S100, the input unit 110 accepts input of the objective function

l(x),
the predetermined number k of nonzero elements, the addition upper limit numbers b₁ to bₘ for respective numbers of times of repetition, and the set [d] of suffixes of the variable vector X.

In step S110, the main processing unit 120 first initializes the set S of nonzero elements to

∅
and initializes the suffix set U to the set [d] of suffixes.

In step S120, the determination unit 140 sets i to 1. Here, i represents a counter that counts the number of times of repetition.

In step S130, the computation unit 130 computes, with respect to each element j that is not included in a set S of nonzero elements that is previously obtained or an initial value of the set S of nonzero elements, an optimum value of the objective function

l(x)
in a case in which elements that are allowed to be nonzero elements are only elements included in a set that is obtained by adding the element j that is not included in the set S of nonzero elements to the set S of nonzero elements.

In step S140, the main processing unit 120 selects added elements j in the ascending order of the optimum values Fⱼ and adds a set Bᵢ of the selected elements j to the previously obtained set S of nonzero elements, the number of selected elements j being the addition upper limit number bᵢ.

In step S150, the main processing unit 120 deletes the elements j included in the set Bᵢ added to the set S of nonzero elements in the above-described step S140 from the suffix set U.

In step S160, the determination unit 140 determines whether or not i is at least m.

If i is smaller than m (NO in the above-described step S160), the determination unit 140 adds 1 to i in step S170 and the routine returns to step S130.

On the other hand, if i is at least m (YES in the above-described step S160), in step S180, the output unit 150 computes a value of the variable vector

### X

that minimizes the value of the objective function
l(x)
when only the set S of nonzero elements is allowed to be nonzero elements, by using the above-described expression (3), based on the objective function
l(x)
and the set S of nonzero elements.

In step S190, the output unit 150 outputs the value of the variable vector

### X

computed in the above-described step S180 as the value that minimizes the value of the objective function
l(x).

As described above, with the high-speed sparse optimization device according to the embodiment of the present invention, it is possible to find a high-quality solution at a high speed even for a nonconvex sparse optimization problem of bad conditions. To realize this, first, an optimum value of the objective function is computed with respect to each element that is not included in a set of nonzero elements that is previously obtained or an initial value of the set of nonzero elements, the optimum value being the optimum value in a case in which elements that are allowed to be nonzero elements are only elements included in a set obtained by adding the element not included in the set of nonzero elements to the set of nonzero elements. Then, the added element is selected in the order of the optimum value of the objective function such that an element with which a preferable optimum value of the objective function can be obtained is preferentially selected, and the selected element is added to the set of nonzero elements. The above-described processing is repeated an addition upper limit number of times that is determined in advance for each number of times of repetition. Here, a total sum of addition upper limit numbers is set to a predetermined number. Thus, a value of the variable vector that optimizes the value of the objective function when only the set of nonzero elements is allowed to be nonzero elements is output, and accordingly, it is possible to find a high-quality solution at a high-speed even for a nonconvex sparse optimization problem of bad conditions by using the high-speed sparse optimization device according to the embodiment of the present invention.

Note that the present invention is not limited to the above-described embodiment, and various modifications and applications can be made within a scope not departing from the gist of the present invention.

In the above-described embodiment, a case is described as an example in which the minimum value of the objective function

l(x)
is the optimum, but this is not a limitation, and the present invention can also be applied to a case in which the maximum value of the objective function
l(x)
is the optimum.

In this case, the computation unit 130 computes, with respect to each element j that is not included in a set S of nonzero elements that is previously obtained or an initial value of the set of nonzero elements, an optimum value of the objective function

l(x)
in a case in which elements that are allowed to be nonzero elements are only elements included in a set that is obtained by adding the element j that is not included in the set S of nonzero elements to the set S of nonzero elements, by using the following expression (4).

$$[ Math . 4 ]$$

$${F}_{j} = {max}_{supp ( x ) ⊆ S ⋃ \{ j \}} l ( x ) \qquad ( 4 )$$

Also, in this case, the main processing unit 120 selects added elements j in the descending order of the optimum values of the objective function

l(x)
and adds the selected elements j to the set S of nonzero elements, the number of selected elements j being the addition upper limit number bᵢ.

Then, based on the objective function

l(x)
and the set S of nonzero elements, the output unit 150 computes a value of the variable vector

### X

that maximizes the value of the objective function
l(x)
when only the set S of nonzero elements is allowed to be nonzero elements, by using the following expression (5).

[Math. 5]

x=argmax_{supp(x′)⊆S}l(x′) (5)

In the embodiment described in the present specification, the program is installed in advance, but the program may also be provided in a state of being stored in a computer-readable recording medium.

### REFERENCE SIGNS LIST

10 High-speed sparse optimization device
110 Input unit
120 Main processing unit
130 Computation unit
140 Determination unit
150 Output unit

1. A high-speed sparse optimization device configured to find a value of a variable vector that optimizes the value of an objective function under the constraint that the variable vector includes at most a predetermined number of nonzero elements, the high-speed sparse optimization device comprising:
a generator configured to generate, with respect to each element that is not included in a set of nonzero elements that is previously obtained or an initial value of the set of nonzero elements, an optimum value of the objective function in a case in which elements that are allowed to be nonzero elements are only elements included in a set that is obtained by adding the element that is not included in the set of nonzero elements to the set of nonzero elements;
a selector configured to select the added elements in the order of optimum values of the objective function and add the selected elements to the set of nonzero elements, the number of selected elements being an addition upper limit number determined in advance for each number of times of repetition such that a sum total of addition upper limit numbers is the predetermined number, the elements being selected such that an element with which a preferable optimum value of the objective function can be obtained is preferentially selected;
a determiner configured to cause the generator to repeatedly perform computation and cause the generator to repeatedly perform selection and addition a predetermined number of times of repetition; and
a provider configured to provide a value of the variable vector that optimizes the value of the objective function when only the set of nonzero elements is allowed to be nonzero elements.

2. The high-speed sparse optimization device according to claim 1, wherein the addition upper limit number determined in advance for each number of times of repetition is greater than or equal to 1, and at least one of the addition upper limit numbers is greater than or equal to 2.

3. A high-speed sparse optimization method for finding a value of a variable vector that optimizes the value of an objective function under the constraint that the variable vector includes at most a predetermined number of nonzero elements, the high-speed sparse optimization method comprising:
generating, by a generator, with respect to each element that is not included in a set of nonzero elements that is previously obtained or an initial value of the set of nonzero elements, an optimum value of the objective function in a case in which elements that are allowed to be nonzero elements are only elements included in a set that is obtained by adding the element that is not included in the set of nonzero elements to the set of nonzero elements;
selecting, by a selector, the added elements in the order of optimum values of the objective function and adding the selected elements to the set of nonzero elements, the number of selected elements being an addition upper limit number determined in advance for each number of times of repetition such that a sum total of addition upper limit numbers is the predetermined number, the elements being selected such that an element with which a preferable optimum value of the objective function can be obtained is preferentially selected;
causing, by a determiner, the generator to repeatedly perform generation and causing the selector to repeatedly perform selection and addition a predetermined number of times of repetition; and
providing, by a provider, a value of the variable vector that optimizes the value of the objective function when only the set of nonzero elements is allowed to be nonzero elements.

4. A computer-readable non-transitory recording medium storing computer-executable program instructions that when executed by a processor cause a computer system to:
generate, by a generator, with respect to each element that is not included in a set of nonzero elements that is previously obtained or an initial value of the set of nonzero elements, an optimum value of the objective function in a case in which elements that are allowed to be nonzero elements are only elements included in a set that is obtained by adding the element that is not included in the set of nonzero elements to the set of nonzero elements;
select, by a selector, the added elements in the order of optimum values of the objective function and adding the selected elements to the set of nonzero elements, the number of selected elements being an addition upper limit number determined in advance for each number of times of repetition such that a sum total of addition upper limit numbers is the predetermined number, the elements being selected such that an element with which a preferable optimum value of the objective function can be obtained is preferentially selected;
cause, by a determiner, the generator to repeatedly perform generation and cause the selector to repeatedly perform selection and addition a predetermined number of times of repetition; and
providing, by a provider, a value of the variable vector that optimizes the value of the objective function when only the set of nonzero elements is allowed to be nonzero elements.

5. The high-speed sparse optimization device according to claim 1, wherein the set of nonzero elements represents a set of true signals after removing one or more noises.

6. The high-speed sparse optimization device according to claim 1, the determiner is based on a multistage greedy algorithm.

7. The high-speed sparse optimization method according to claim 3, wherein the addition upper limit number determined in advance for each number of times of repetition is greater than or equal to 1, and at least one of the addition upper limit numbers is greater than or equal to 2.

8. The high-speed sparse optimization method according to claim 3, wherein the set of nonzero elements represents a set of true signals after removing one or more noises.

9. The high-speed sparse optimization method according to claim 3, the determiner is based on a multistage greedy algorithm.

10. The computer-readable non-transitory recording medium according to claim 4, wherein the addition upper limit number determined in advance for each number of times of repetition is greater than or equal to 1, and at least one of the addition upper limit numbers is greater than or equal to 2.

11. The computer-readable non-transitory recording medium according to claim 4, wherein the set of nonzero elements represents a set of true signals after removing one or more noises.

12. The computer-readable non-transitory recording medium according to claim 4, the determiner is based on a multistage greedy algorithm.
